(19) United States
(12) Patent Application Publication
(10) Pub. No.: US 2009/0071410 A1
(43) Pub. Date: Mar. 19, 2009

(54) LIVERPOOL APPARATUS

(76) Inventors: Rebecca Lewis, Newport Beach, CA (US); Paul Berman, Santa Monica, CA (US)

Correspondence Address: LAW OFFICE OF MAI VU PARE, 9107 WILSHIRE BLVD. #450, BEVERLY HILLS, CA, 90210, US

(21) Appl. No.: 11/856,054

(22) Filed: Sep. 16, 2007

(51) Int. Cl. A01K 15/02

(52) U.S. Cl. 119/705

(57) ABSTRACT

The present invention relates to a novel liverpool apparatus for use in show jumping, a category of equestrian events. Said apparatus allows a user to provide at least two types of liverpools using a single apparatus.

### BACKGROUND OF THE INVENTION

The present invention relates to “show jumping”, a category within English riding equestrian events. Specifically, the invention relates to an obstacle a horse must clear within a course.

Show jumping is an English riding sport requiring riders to guide their horses through a series of obstacles and challenges set up within a course. Obstacles may include fences, hedges, gates, walls, shrubs, plants, planks, flowers, rails, and water jumps either alone or in combination. Horses are expected to clear obstacles of various widths and heights, with some jumps spanning distances of up to 16 feet in width and a little over 5 feet vertically. Scoring is accomplished through objective criteria based on the speed and ability of competing horses to complete such courses without error.

Water may be incorporated in show jumping courses and are intended for horses to jump over, rather than cross. For competition purposes, if a foot of a horse passes or touches water within a jump this is considered a fault and negatively affects the rider's score in competition. Water may be incorporated in a course through 1) open water and/or 2) a wet liverpool.

With “open water” obstacles, a large, rectangular ditch is filled with water. The competing horse may be required to jump a span as wide as 16 feet. A vertical fence or shrub may be provided at the leading edge of the jump. Open water jumps are one of the widest distances a horse may be required to jump within a course.

A liverpool is used in conjunction with a vertical or oxer fence, requiring a horse to clear a horizontal span created by the liverpool and or oxer and a vertical distance created by a vertical or oxer fence. Vertical fences comprise multiple rails or planks placed above each other within the same vertical plane, requiring a horse to clear the vertical distance. Oxer fences comprise parallel sets of rails positioned horizontally from each other, creating a horizontal span. Below such fences, liverpools may be placed to increase the difficulty for the horse and rider, as he/she must clear both a vertical and horizontal span.

Prior art liverpools used in show jumping may also comprise “dry” liverpools. Dry liverpools also create horizontal spans that a horse must clear and are placed beneath a vertical or oxer fence. Dry liverpools do not incorporate the use of water but rather, represent a horizontal obstacle that a horse must not touch when clearing. A dry prior art liverpool may comprise a rectangular tarp, canvas, or rigid material and may have a black or blue color.

When clearing obstacles in show jumping courses, a horse approaches an obstacle, observes the nature of the obstacle and attempts to clear it. A horse must prepare to clear an obstacle in differing manners depending on the nature, type, and scope of the obstacle. Liverpools provide challenge to a horse because they force a horse to look downward just prior to clearing a vertical height represented by a fence.

A shortcoming of prior art liverpools is that no single liverpool incorporates more than one type of liverpool. Prior art liverpools only allow for the use of either a dry or wet type of liverpool per apparatus. If a horse is only trained to use one type of liverpool, a horse may be surprised and commit a fault when competing in courses using less familiar types of liverpools. A horses performance and score may be negatively affected.

In addition, because prior art liverpools only expose a horse to one type of liverpool per apparatus, a horse may be conditioned to clearing obstacles based on memory, rather than observation. When competing in unfamiliar courses, a horse is required to observe obstacles and prepare to clear them accordingly. In practice, too much reliance on memory will not prepare a horse to rely on observation to clear an obstacle and to compete well in unfamiliar courses.

An additional shortcoming of the prior art is that in order to train a horse to the various types of liverpools, either multiple liverpools must be set-up or a liverpool must be disassembled and replaced with a different type of liverpool.

It is an object of the present invention to provide an apparatus that allows a rider to guide a horse through two types of liverpools, using a single apparatus.

It is an additional object of the present invention to provide a liverpool that provides additional challenge to a horse and creates an element of surprise in clearing an obstacle.

It is also an object of the present invention to provide an apparatus that encourages a horse to use observation in clearing an obstacle, rather than rely on memory alone.

### SUMMARY OF THE INVENTION

The present invention is a novel liverpool that comprises more than one form of a liverpool within one apparatus. The form of liverpool a horse will observe will depend on which side of a fence a horse approaches the liverpool. Wet or dry forms of liverpools may be provided using a single apparatus when using the present invention.

### BRIEF DESCRIPTION OF THE DRAWINGS

FIG. 1 depicts a perspective view of a first embodiment of the present invention.

FIG. 2 depicts a perspective view of an alternative embodiment of the first embodiment of the present invention having a handle and hinged feature.

FIG. 3 depicts the first embodiment of the present invention in use.

FIG. 4 depicts a perspective view of a second embodiment of the present invention.

FIG. 5 depicts a perspective view of a third embodiment of the present invention.

### DETAILED DESCRIPTION OF THE INVENTION

Reference will now be made in detail to the preferred embodiment of the invention, examples of which are illustrated in the accompanying drawings. Wherever possible, the same reference numbers will be used throughout the illustration to refer to the same or like parts.

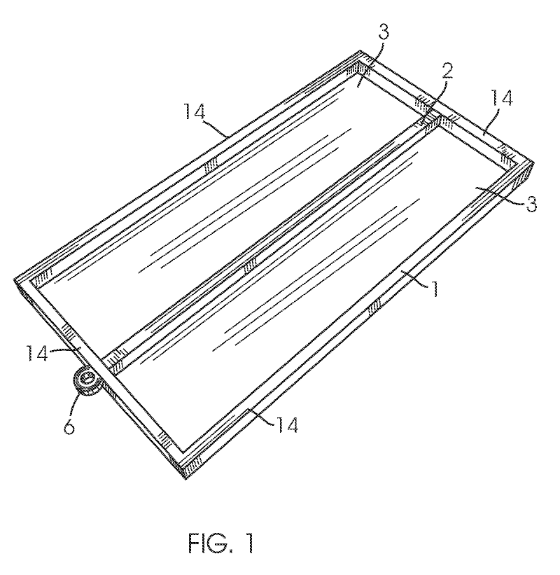

FIG. 1 shows the preferred embodiment of a first embodiment of the invention comprising a receptacle 1 separated by a dividing wall 2, forming two separate chambers 3. Multiple dividing walls may be provided however, to form more than two chambers and still fall within the scope of the invention. One chamber may be painted a first color and the second chamber may be painted a second color.

In the preferred embodiment of the first embodiment, one chamber is colored a blue color and the second chamber is colored a black color. The dividing wall 2 and perimeter 14 of the receptacle may extend vertically in a distance sufficient so that a chamber may contain water or other liquid. This enables the user to fill at least one chamber with liquid to create a wet liverpool.

In FIG. 1, the embodiment possesses a rectangular shape, which is the standard shape of prior art liverpools. The present invention is not limited to a rectangular shape however, and other shapes including circular, oval, square, or other parallelograms may be used and still fall within the scope of the invention. At least one flange 6 may be provided on the apparatus.

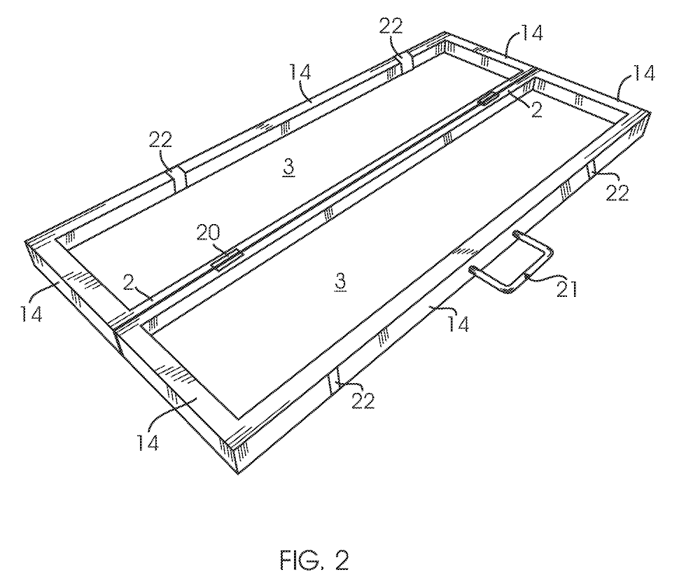

FIG. 2 depicts an alternative embodiment of the first embodiment wherein two chambers 3 comprise separable elements. Said separable elements may be joined together by hinged units 20. The hinged units allow for movement of the chambers along the axis of the dividing walls 2. At least one chamber comprises a dividing wall 2 and perimeter 14 that extends vertically so that said chamber may contain liquid such as water.

The hinged units may be constructed from metal, plastic, or other materials known in the art. The alternative embodiment may further comprise at least one handle 21. Said handle may be constructed from metal, plastic, wood, or other durable material. The apparatus may be conveniently transported by folding the two chambers towards each other, along the hinged units. The resulting dimension of the apparatus is reduced by half. Clasps, Velcro, or other closure means 22 may be provided so that the two chambers may be secured together while a user transports the apparatus.

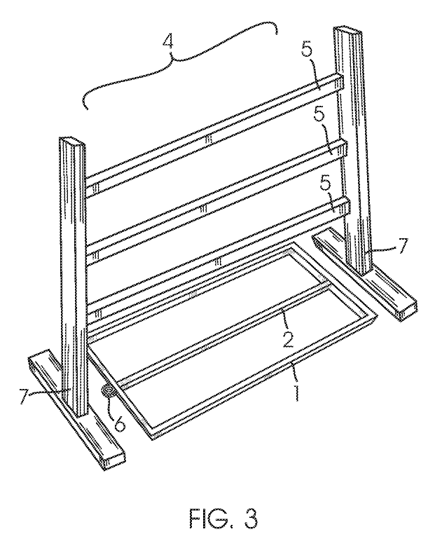

Referring to FIG. 3, Use of the invention is accomplished similarly to prior art liverpools, by placement of the invention below a vertical 4 or oxer fence (not shown) so that the dividing wall 2 runs in the same vertical plane as a rail 5 from the fence. The resulting arrangement enables the user to provide a wet and dry liverpool using a single apparatus. As a horse attempts a jump, it may observe either a wet or dry liverpool depending on which side of the fence it approaches on a jump.

At least a portion of the receptacle may comprise rigid, non-porous material such as metal, polyvinyl chloride, vinyl, plastic, wood or a combination of said materials. The non-porous material allows the receptacle to hold liquid. UV blocking agents may be incorporated in plastic embodiments of the invention to prolong use and delay cracking or breakdown from exposure to the sun. The flange 6 provided on the apparatus allows for attachment of the apparatus to a post 7 from a vertical or oxer fence through means such as a wire, cable, or rope.

In the preferred embodiment of the invention, dimensions of the apparatus approximate 9½ feet by 4½ feet, however the scope of the invention is not intended to be limited to these dimensions, and other sizes may be used depending on course regulations, dimensions of the fence for which the apparatus is to be used in conjunction with the apparatus, and course design.

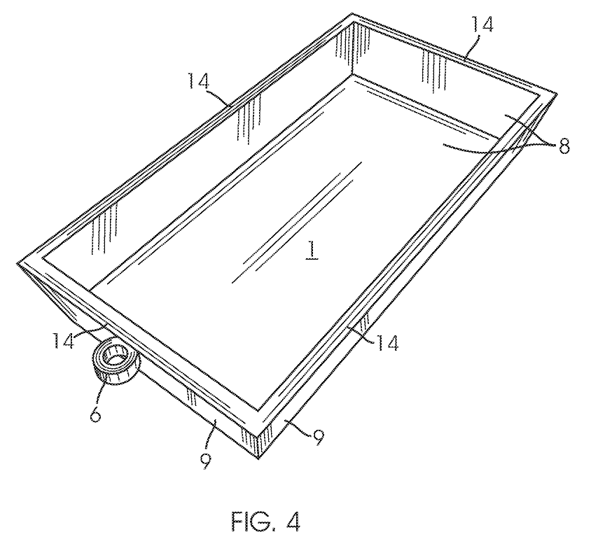

FIG. 4 shows a second embodiment of the invention, comprising a receptacle 1. The receptacle may have a rectangular shape. Other shapes such as oval, circular, square, or other parallelograms may be provided however and still fall within the scope of the invention.

The interior 8 of the receptacle may be painted a first color. At least some portion of the interior of the receptacle may be lined with non-porous material so that a liquid does not pass through. A perimeter 14 of the receptacle may extend in a vertical direction enabling the receptacle to contain the liquid. The outer surface 9 of the receptacle may be painted a second color. In the preferred embodiment of the second embodiment the interior of the receptacle is painted blue and the outer surface is painted black. When the apparatus is positioned with the interior of the receptacle placed in a downward position, only a black raised platform is visible to an observer.

Use of the second embodiment of the invention is accomplished in a similar manner to conventional liverpools. In contrast to prior art liverpools, the user can choose to set a jump with a wet liverpool by exposing the interior of the receptacle and filling it with water or a dry liverpool by placing the interior of the apparatus in a downward position. When placed below a fence, the invention appears similar to conventional dry or wet liverpools depending on which position the apparatus is oriented.

Similar to the first embodiment of the present invention, the second embodiment may be constructed from metal, polyvinyl chloride, vinyl, plastic, wood or a combination of said materials. UV blocking agents may be incorporated in embodiments constructed from plastic to delay breakdown from sun exposure. At least one flange 6 may be provided on the apparatus for attachment to a post from a fence.

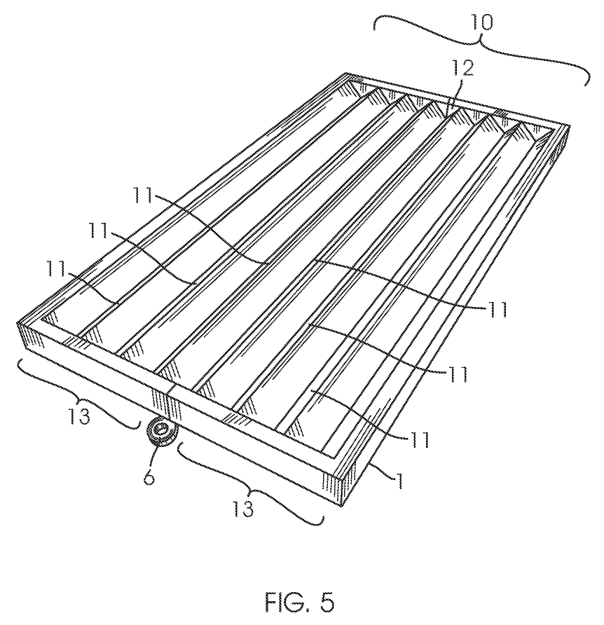

FIG. 5 depicts a third embodiment of the present invention. The third embodiment comprises a receptacle 1 having a corrugated surface 10 with ridges 11 that may be painted in alternating arrangements of a first and second color. In the preferred embodiment of the third embodiment the ridges are painted in alternating arrangements of blue and black. The alternating arrangement of blue and black ridges creates a visual effect wherein depending on which side an observer approaches the liverpool, either a blue or black liverpool is observed.

The third embodiment may further comprise a center line 12, indicating the location on the apparatus comprising two equal areas 13. Water may be filled within at least one of the areas to provide a wet liverpool. Use of the apparatus is accomplished similarly to the first embodiment by placement below a fence, with the center line 12 running in the same vertical plane as a rail from the fence. This results in the appearance of two types of liverpools within a single apparatus. Either a wet or dry liverpool is viewed by an observer depending on which side of the apparatus the observer approaches.

The third embodiment may be constructed from non-porous, rigid material such as metal, polyvinyl chloride, vinyl, plastic, wood or a combination of said materials. UV blocking agents may be incorporated in plastic embodiments to delay breakdown and cracking from exposure to the sun. At least one flange 6 may be provided on the apparatus for attachment to a post from a fence.

With respect to the above description, it is to be realized that the optimum dimensional relationships for the parts of the invention, to include variations in size, materials, shape, form, function, manner and use are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. An apparatus for use as a liverpool comprising:
a receptacle;
said receptacle comprising a perimeter; and
said receptacle further comprising a dividing wall forming at least two separate chambers.

2. The apparatus claimed in claim 1 further comprising a flange for attachment to a post.

3. The apparatus claimed in claim 1 wherein one chamber is painted a first color and a second chamber is painted a second color.

4. The apparatus claimed in claim 1 wherein at least a portion of the receptacle comprises non-porous material.

5. The apparatus claimed in claim 1 wherein said receptacle has a rectangular shape.

6. The apparatus claimed in claim 1 wherein said receptacle is constructed from plastic.

7. The apparatus claimed in claim 1 wherein said receptacle is constructed from plastic with said plastic incorporating UV blocking agents.

8. The apparatus claimed in claim 1 wherein said chambers comprise rotatable elements; and
said chambers are joined by hinge units.

9. The apparatus claimed in claim 1 wherein said chambers comprise rotatable elements;
said chambers are joined by hinge units;
at least one chamber may further comprise a handle; and
at least one chamber comprises a closure means.

10. An apparatus for use as a liverpool comprising:
a receptacle;
said receptacle comprising a perimeter and an interior;
said interior further comprising a portion including a non-porous material;
said receptacle further comprising an outer surface so that when the receptacle is placed with said interior facing downward, a raised platform is observed.

11. The apparatus of claim 10 wherein said interior is painted a first color and said outer surface is painted a second color.

12. The apparatus of claim 10 wherein said receptacle is constructed from plastic material.

13. The apparatus of claim 10 wherein said receptacle is constructed from plastic material and UV blocking agents are incorporated in said plastic material.

14. The apparatus of claim 10 wherein said receptacle further comprises a flange for attachment to a post.

15. The apparatus of claim 10 wherein said receptacle comprises a rectangular shape.

16. An apparatus for use as a liverpool comprising:
a receptacle;
said receptacle further comprises a corrugated surface formed by ridges.

17. The apparatus of claim 16 wherein said ridges are colored in an alternating pattern of a first and a second color.

18. The apparatus of claim 16 wherein said receptacle further comprises a flange for attachment to a post.
